(19) United States
(12) Patent Application Publication
(10) Pub. No.: US 2026/0265470 A1
(43) Pub. Date: Sep. 10, 2026

(54) POLYAMIDE MOLDING COMPOSITION WITH ENHANCED FIRE RESISTANCE

(71) Applicant: SOLVAY SPECIALTY POLYMERS USA, LLC, Alpharetta, GA (US)

(72) Inventors: Gaetano Calvaruso, Pforzheim (DE); Gaurav Amarpuri, Alpharetta, GA (US); Krishnan Balaji Thattai Parthasarathy, New York, NY (US); Rhys James Tapper, Anaheim, CA (US); Keshav S. Gautam, Suwanee, GA (US)

(73) Assignee: SOLVAY SPECIALTY POLYMERS USA, LLC, Alpharetta, GA (US)

(21) Appl. No.: 19/166,000

(22) PCT Filed: Mar. 15, 2024
(86) PCT No.: PCT/EP2024/057095

§ 371 Date: Sep. 16, 2025

Related U.S. Application Data
(60) Provisional application No. 63/490,812, filed on Mar. 17, 2023.

(30) Foreign Application Priority Data
Sep. 8, 2023 (EP) 23196163.2

(51) Int. Cl. C08J 5/04; B60L 50/64; C08K 7/14; H01M 50/122; H01M 50/162; H01M 50/229; H01M 50/28

(52) U.S. Cl. CPC C08J 5/043; C08K 7/14; H01M 50/122; H01M 50/162; H01M 50/229; H01M 50/28; B60L 50/64; C08J 2377/06; C08K 2201/004

(57) ABSTRACT

A polyamide molding composition including at least one polyamide (PA), glass fibers (GFs), and at least one flame retardant (FR), wherein a time of failure (t_{F}) of the composition is at least 5.0 min, preferably at least 6.0 min, more preferably at least 10.0 min, and to a polyamide molding composition including at least one PA, GFs, and at least one FR, wherein the distribution of the lengths of the GFs is characterized by an arithmetic average length (Lₐᵥ) of 220 μm or more; and the proportion of the GFs having a length higher than 400 μm is at least 20% (in numbers). An article including said composition, and to use of the glass fibers and a flame retardant in improving thermal resistance of a polyamide molding composition.

This application claims priority of U.S. patent application No. 63/490,812 filed on 17 Mar. 2023 and European patent application No. 23196163.2 filed on 8 Sep. 2023, the content of which being entirely incorporated herein by reference for all purposes. In case of any incoherency between this application and the two applications that would affect the clarity of a term or expression, it should be made reference to this application only.

### TECHNICAL FIELD

The present invention relates to a polyamide molding composition that can be used for preparing battery enclosures and other parts of a battery.

### Technical Problem

With the development of electric vehicles (EVs) and the need to decrease the weight of many components, the original equipment manufacturers (OEMs) are looking for battery enclosures and other parts of the battery that are made with polymeric materials.

Thermal runaway of lithium-ion cells occurs sometimes when the lithium-ion cells enter an uncontrollable self-heating state that may result in fire, smoke and extremely high temperatures while ejecting harmful substances.

Battery performance has continually presented challenges in EV efficiency. Battery enclosure systems play a critical role in mitigating the impact of thermal runaway, a risk associated with lithium-ion batteries. Any unwanted thermal runaway should be confined in a battery enclosure so as to avoid that the burst of heat and energy escapes into the rest of the vehicle.

Moreover, due to the increased temperature of a battery cell undergoing a thermal runaway, the temperature of adjacent cells within the battery will also increase, which can lead to an instability and thermal runaway of the adjacent cells in a cascading way. The configuration of the battery may thus contain walls separating the cells or the packs of cells within the battery enclosure. The material of these walls and other parts of the battery enclosure should also withstand the thermal runaway and be resistant enough to confine the runaway.

The polymeric material should also preferably exhibit a combination of good mechanical properties (such as resistance to impact and tensile strength) and thermal resistance, notably in case of a thermal runaway.

There is therefore the need to develop a polymeric material used for the preparation of a battery enclosure and other parts of the battery that can withstand and contain any thermal runaway and resist to the dynamic stress triggered by the runaway.

The invention and the polymeric material of the invention aim at solving this technical problem.

### BACKGROUND OF THE INVENTION

Flame resistant polymeric materials have been known for a long time but the materials developed do not aim at solving the problem of a dynamic thermal runaway.

CN 115785663 (D1) provides a halogen-free flame-retardant nylon material for battery pack shells comprising 40-67 parts of a polyamide 6 or 66, 20-30 parts of GF, 5-10 parts of modified melamine polyphosphate, 4-10 parts of aluminum diethyl hypophosphite, 0.1-0.5 parts of a chain extender, 3-8 parts of toughening agent and 1-2 parts of other additives. The toughening agent is a polymer with maleic anhydride.

US 2014/0363654 A1 (D2) (EMS-Patent AG) discloses a polyamide molding composition consisting of at least one polyamide, glass fibers, where the arithmetic average of the length of these glass fibers in the polyamide molding composition is from 100 to 220 μm, at least one phosphinic salt and/or at least one diphosphinic salt, and optionally at least one additive, exhibiting V0 rating at 3.2 mm according to UL-94 (Underwriters Laboratories-94: Tests for flammability of plastic materials for parts in devices and appliances).

US 2012/029124 (D3) discloses a polymer composition comprising: at least one semi-aromatic polyamide having a melting point of at least 270° C.; at least one organophosphorous compound selected from the group consisting of a phosphinic salt, a diphosphinic salt and condensation products thereof; and at least 0.01 wt %, based on the total weight of the composition, of calcium oxide. D3 does not disclose any time of failure nor any size of the GFs in the polyamide composition.

US 2023/183454 (D4) discloses an electrical or electronic article comprising a semi-crystalline polyamide and glass fibers. D4 does not disclose any time of failure nor any size of the GFs in the polyamide composition.

US 2023/183452 (D5) discloses a composition comprising a semi-crystalline polyamide and glass fibers. D5 does not disclose any time of failure nor any size of the GFs in the polyamide composition.

EP 4191757 A1 (D6) discloses a thermal runaway protection film for a lithium ion battery, the film comprising at least one protection layer comprising at least one silicone and at least one silicate compound in an amount of at least 40 wt %, based on the total weight of the at least one protection layer. D6 does not disclose the composition of the invention.

US 2014/0275367 A1 (Cheil Industries Inc.) discloses adding polyphenylene sulfide to a reinforced polyamide composition, which exhibit satisfactory flame-retardant performances while reducing the amount of the flame retardant required.

U.S. Pat. No. 10,435,540 B2 (SABIC) discloses another approach using pellets having a particular structure consisting of a core and a sheath, wherein a core contains glass fibers and an impregnating agent, and a sheath surrounding said core contains polypropylene and a mixture of an organic phosphate compound, an organic phosphoric acid compound and zinc oxide as flame retardants.

WO 2024/022878 discloses a battery pack and a battery enclosure. The polyamide molding composition of the invention is not disclosed.

### SUMMARY OF THE INVENTION

The invention is as disclosed below and in the appended claims.

The invention first relates to a polyamide molding composition as defined in any one of claims 1-36.

The invention also relates to an article as defined in any one of claims 37-38.

The invention also relates to a method of preparation of pellets (p) as defined in claim 39 or 40.

The invention also relates to pellets (p) as defined in claim 41.

The invention also relates to the use as defined in claim 42 or 43 and to the method of manufacture as defined in claim 44.

The invention also relates to the use as defined in claim 45.

The various aspects, advantages, and features of the invention will be more readily understood and appreciated by reference to the detailed description and examples.

### BRIEF DESCRIPTION OF DRAWINGS

FIG. 1 illustrates the number-weighted distribution of the length of glass fibers in density function versus fiber length (in μm) corresponding to Inventive Example 1 (E1) and Comparative Example 1 (CE1).

FIG. 2 shows the equipment setup for the torch test T1.

### DEFINITIONS

In the context of the present invention, the term ‘percent by weight’ (wt %) indicates the content of a specific component in a mixture, calculated as the ratio between the weight of the component and the total weight of the mixture.

As used herein, the terminology ‘Cₙ-Cₘ’ in reference to an organic group, wherein n and m are integers, respectively, indicates that the group may contain from n carbon atoms to m carbon atoms per group.

As used herein, a “semi-crystalline” polyamide exhibits a heat of fusion (Hₘ) of at least 5.0 Joules per gram (J/g), measured by differential scanning calorimetry (DSC) according to ASTM D3418 at a heating rate of 20° C./min. Similarly, as used herein, an “amorphous” polyamide exhibits a heat of fusion (Hₘ) of less than 5.0 J/g, preferably of less than 3.0 J/g, and more preferably of less than 2.0 J/g, measured using DSC at a heating rate of 20° C./min.

As used herein, the term ‘alkyl’ groups include saturated hydrocarbons having one or more carbon atoms, including straight-chain alkyl groups, such as methyl, ethyl, propyl, butyl, pentyl; cyclic alkyl groups (or ‘cycloalkyl’ or ‘alicyclic’ or ‘carbocyclic’ groups), such as cyclopropyl, cyclopentyl, cyclohexyl, cycloheptyl, and cyclooctyl; branched-chain alkyl groups, such as isopropyl, tert-butyl, sec-butyl, and isobutyl; and alkyl-substituted alkyl groups, such as alkyl-substituted cycloalkyl groups and cycloalkyl-substituted alkyl groups. As used herein, the term ‘alkylene’ groups refer to bivalent saturated hydrocarbons having one or more carbon atoms and the term ‘cycloalkylene’ groups refer to bivalent saturated cyclic hydrocarbons having at least three carbon atoms.

The term ‘aliphatic group’ includes organic moieties characterized by straight or branched-chains, typically having C₁-C₅₀. In complex structures, the chains may be branched, bridged, or cross-linked. Aliphatic groups include alkyl groups, alkenyl groups, and alkynyl groups.

As used herein, the term ‘aryl’ groups include aromatic hydrocarbons, for instance a phenyl, indanyl, and naphthyl group. The aryl group may comprise one or more alkyl groups, and are called sometimes in this case “alkylaryl”; for example may be composed of an aromatic group and two C₁-C₆ groups. The aryl group may also comprise one or more heteroatoms, e.g. N, O or S, and are called sometimes in this case ‘heteroaryl’ group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from, but not limited to, halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied. As used herein, the term ‘arylene’ groups refer to aromatic hydrocarbons which are bivalent, such as phenylene.

The term ‘halogen’ or ‘halo’ includes fluorine, chlorine, bromine and iodine.

In the present application, unless otherwise indicated, any specific embodiment or technical feature relating to one of the subject-matters of the invention is applicable to and interchangeable with another embodiment or technical feature relating also to said subject matter and disclosed elsewhere in the application.

### DETAILED DESCRIPTION OF THE INVENTION

### About the Polyamide Molding Composition

The polyamide molding composition of the invention comprises:
at least one polyamide (PA);
glass fibers (GFs); and
at least one flame retardant (FR); and
optionally at least one additive (Add) other than the flame retardant (FR), notably selected from the group consisting of impact modifiers, tougheners, plasticizers, colorants, pigments, antistatic agents, dyes, lubricants, thermal stabilizers, light stabilizers, antioxidants, nucleating agents, polymer processing aids, anti-blocking agents, slip agents, antifogging agents, chemical blowing agents, nucleating agents and any combination thereof.

The glass fibers (GFs) are present in the molding composition as being blended with the PA and the FR.

All components of the polyamide molding composition (e.g. polyamide(s) (PA), GFs, FR(s) and additive(s) (Add) (if any)) are typically blended.

In one embodiment of the present invention, the proportion of the GFs is between 20.0 and 60.0 wt % or between 30.0 and 55.0 wt %. This proportion may be between 30.0 and 50.0 wt %.

In another embodiment of the present invention, the proportion of the FR(s) is between 10.0 and 30.0 wt %. This proportion may be between 10.0 and 20.0 wt %.

In another embodiment of the present invention, the proportion of the PA(s) is between 35.0 and 65.0 wt %. This proportion may be between 35.0 and 60.0 wt % or between 35.0 and 55.0 wt %.

In another embodiment of the present invention, the proportion of additives (Add) is between 0 and 10.0 wt %.

All these proportions in wt % are provided relative to the weight of the polyamide molding composition.

More particularly, the polyamide molding composition of the invention comprises or consists of:
between 35.0 and 65.0 wt % of at least one polyamide (PA);
between 20.0 and 60.0 wt % of glass fibers (GFs);
between 10.0 and 30.0 wt % of at least one flame retardant (FR); and
between 0 and 15.0 wt % of at least one additive (Add) other than the flame retardant (FR), notably selected from the group consisting of impact modifiers, tougheners, plasticizers, colorants, pigments, antistatic agents, dyes, lubricants, thermal stabilizers, light stabilizers, antioxidants, nucleating agents, polymer processing aids, anti-blocking agents, slip agents, antifogging agents, chemical blowing agents, nucleating agents and any combination thereof.

More particularly, the polyamide molding composition of the invention comprises or consists of:
between 35.0 and 60.0 wt % of at least one polyamide (PA);
between 30.0 and 55.0 wt % of glass fibers (GFs);
between 10.0 and 30.0 wt % of at least one flame retardant (FR); and
between 0 and 15.0 wt % of at least one additive (Add) other than the flame retardant (FR), notably selected from the group consisting of impact modifiers, tougheners, plasticizers, colorants, pigments, antistatic agents, dyes, lubricants, thermal stabilizers, light stabilizers, antioxidants, nucleating agents, polymer processing aids, anti-blocking agents, slip agents, antifogging agents, chemical blowing agents, nucleating agents and any combination thereof.

The polyamide molding composition may comprise one or more polyamide (PA). According to one embodiment, the polyamide molding composition comprises only one polyamide (PA). The polyamide molding composition preferably does not comprise another polyamide other than the polyamide (PA).

According to another embodiment, the polymer component of the polyamide molding composition consists of one or more polyamides (PA).

### Distribution of the GFs in the Polyamide Molding Composition

The polyamide molding composition is also characterized by a specific distribution of the size of the GFs in the polyamide molding composition. This distribution corresponds to the distribution of the lengths of the GFs as dispersed in the polyamide molding composition. The distribution is generally obtained by observing with a microscope a statistically significant number n (e.g. at least 200, even at least 5000) of glass fibers separated from the polyamide molding composition.

The observation and the determination of the distributions may be performed automatically, as is disclosed for instance in WO 2008/033789.

The polyamide molding composition can be notably characterized by set of parameters (S1) or (S2) or by sets of parameters (S1) and (S2), these sets being as defined herein. The polyamide molding composition can also be characterized by set of parameters (S1*) or (S2*) or by sets of parameters (S1*) and (S2*), these sets being as defined herein.

### Number-Weighted Distribution of the Length of the GFs

The number-weighted distribution provides the numbers of GFs having a specified length L. In a number-weighted distribution, each GF is given equal weighting irrespective of its length.

From this number-weighted distribution, it is possible to calculate the arithmetic average length of the GFs. Lₐᵥ is the arithmetic average length according to the following formula:

$$L a v = \frac{{\sum }_{i = 1}^{i = n} L i}{n}$$

where:
   Li is the length of the i^{th} fiber;
   n is the number of fibers measured.
      Moreover, from this number-weighted distribution, it is observed that the polyamide molding composition is characterized by a significant proportion of GFs having a certain length L.

The polyamide molding composition can be characterized by set of parameters (S1):

(S1)

an arithmetic average length (Lₐᵥ) of 220 μm or more; and
a proportion of the GFs having a length higher than 400 μm of at least
20% (in numbers) and/or a proportion of the GFs having a length higher
than 500 μm of at least 15.0% (in numbers).

Thus, the polyamide molding composition of the invention can be characterized by:
an arithmetic average length (Lₐᵥ) of 220 μm or more; and
a proportion of the GFs having a length higher than 400 μm being at least 20% (in numbers), preferably at least 25% (in numbers), preferably at least 30% (in numbers), preferably at least 35% (in numbers), preferably at least 40% (in numbers), preferably at least 45% (in numbers), preferably at least 50% (in numbers).

The polyamide molding composition of the invention can more particularly be characterized by:
an arithmetic average length (Lₐᵥ) which is between 300 and 750 μm, preferably between 300 and 700 μm; and
a proportion of the GFs having a length higher than 400 μm being at least 45% (in numbers), preferably at least 50% (in numbers).

The proportion of the GFs having a length higher than 400 μm is typically between 45% (in numbers) and 90% (in numbers).

The polyamide molding composition of the invention can also be characterized by:
an arithmetic average length (Lₐᵥ) of 220 μm or more; and
a proportion of the GFs having a length higher than 500 μm being at least 15.0% (in numbers), preferably at least 20.0% (in numbers), preferably at least 25.0% (in numbers), preferably at least 30.0% (in numbers).

The polyamide molding composition of the invention can more particularly be characterized by:
an arithmetic average length (Lₐᵥ) which is between 300 and 750 μm, preferably between 300 and 700 μm; and
a proportion of the GFs having a length higher than 500 μm being at least 30.0% (in numbers).

The proportion of the GFs having a length higher than 500 μm is typically between 30.0% (in numbers) and 80.0% (in numbers).

The glass fibers have an arithmetic average length (Lₐᵥ) of 220 μm or more. Lav is preferably strictly higher than 220 μm. Lav is preferably at least 300 μm or at least 400 μm.

In one embodiment, Lₐᵥ is between 220 μm and 600 μm. Lav is more particularly between 250 μm and 600 μm, preferably between 270 μm and 550 μm. Lav is more preferably between 300 and 400 μm.

In one embodiment, Lₐᵥ is between 220 μm and 750 μm or between 220 μm and 700 μm. Lₐᵥ is more particularly between 300 and 750 μm or between 300 and 700 μm.

Typically, from this number-weighted distribution, it appears that at least 90.0% (in numbers) of the GFs have a length lower than or equal to 3000 μm, preferably lower than or equal to 2500 μm.

### Volume-Weighted Distribution of the Length of the GFs

The volume-weighted distribution provides the volume (or weight) of the GFs having a specified length L. Here, the contribution of each GF in the distribution relates to its volume. The volume Vi of the ith fiber is taken as: Vi=(π r²)×Li where r is the radius of the GFs. The radius of the GFs used for the preparation of the polyamide molding composition is known (corresponding to the diameter of the GFs used as starting material) and is taken as being the same for all the GFs.

Whereas in a number-weighted distribution, the % are expressed in number, in a volume-weighted distribution, the % are expressed in volume.

From the volume-weighted distribution, it is possible to calculate the following average length Lₚ of the GFs with the following equation:

$$Lp = \frac{{\sum }_{i = 1}^{i = n} ni \times Li \times Li}{{\sum }_{i = 1}^{i = n} ni \times Li}$$

where:
ni is the number of glass fibers of length Li;
n is the number of glass fibers measured.

Moreover, from this volume-weighted distribution, it is observed that the polyamide molding composition is characterized by a significant proportion of GFs having a certain length L.

The polyamide molding composition can be characterized by set of parameters (S2):

(S2)

an average length (Lₚ) between 400 μm and 1800 μm;
a proportion of the GFs having a length higher than 400 μm of at least
50.0% and/or a proportion of the GFs having a length higher than 500 μm
of at least 40.0%.

Thus, the polyamide molding composition of the invention can be characterized from this volume-weighted distribution by:
an average length (Lₚ) between 400 μm and 1800 μm;
a proportion of the GFs having a length higher than 400 μm being at least 50.0%, preferably at least 60.0%, preferably at least 65.0%, preferably at least 70.0%.

The polyamide molding composition of the invention can more particularly be characterized by:
an average length (Lₚ) between 400 μm and 1800 μm; and
a proportion of the GFs having a length higher than 400 μm being at least 65.0%.

The proportion of the GFs having a length higher than 400 μm is typically between 65.0% and 100%.

The polyamide molding composition of the invention can also be characterized from this volume-weighted distribution by:
an average length (Lₚ) between 400 μm and 1800 μm;
a proportion of the GFs having a length higher than 500 μm being at least 40.0%, preferably at least 50.0%, preferably at least 55.0%.

The polyamide molding composition of the invention can more particularly be characterized by:
an average length (Lₚ) between 400 μm and 1800 μm; and
a proportion of the GFs having a length higher than 500 μm being at least 50.0%.

The proportion of the GFs having a length higher than 500 μm is typically between 50.0% and 100%.

Lp is between 400 μm and 1800 μm or between 400 μm and 1700 μm.

Lp is preferably at least 450 μm, preferably at least 500 μm.

Number n corresponds to a statistically significant number of GFs observed. Number n is typically at least 200, preferably at least 500, preferably at least 5000.

Both the number-weighed and the volume-weighted distributions are obtained after the separation of the GFs from the polyamide molding composition. This separation may be performed according to one of the methods specified below.

### Ash Method (a)

The separation of the GFs may be performed by any one of the ash methods disclosed herein.

The separation of the GFs may be performed by the ash method (a) which comprises the following steps:
(a1) heating a sample of the polyamide molding composition in a furnace; and
(a2) recovering the glass fibers.

The temperature at which step (a1) is performed should preferably allow the decomposition of polymeric component without degrading the glass fibers (GFs). It is preferable that the decomposition takes place smoothly without degradation of the GFs.

The temperature at which step (a1) is performed is generally at least 500° C.

The duration of step (a1) should be long enough to allow the decomposition of the polymeric component. The step (a1) is generally implemented until the weight of the burnt sample no longer evolves.

A muffle furnace can be used for the ash method (a).

Method (a) may preferably be one of the two following specific methods:

(a1) placing a sample (e.g. 1.0 g) in a muffle furnace at more than 500° C.
(e.g. 525° C.) to allow the sample to ash (duration of at least 12 hours);
and
(a2) recovering the glass fibers.

(a1) placing a sample (e.g. 1.0 g) in a muffle furnace at 625° C. for
90 minutes; and
(a2) recovering the glass fibers.

The separation may preferably be performed by the ash method disclosed in ISO 22314:2006(E). It may be noted that the ash method disclosed in ISO 22314:2006(E) may be adapted with a variation of the temperature at which the sample is heated.

### Chemical Method (b)

The separation of the GFs may be performed by any one of the chemical methods disclosed herein.

The separation may also be performed by the chemical method (b) which comprises the following steps:
(b1) heating a dispersion of the sample in a solution of sulfuric acid; and
(b2) recovering the glass fibers.

Step (b1) is performed until the polyamide molding composition dissolves in an acidic solution. A concentrated solution (e.g. at least 98.0 wt %) is preferably used. The temperature at which step (b1) is performed is at least 200° C.

Method (b) may more particularly be the following one:
adding 1.0 g of a sample with a stirring bar to a 150 mL of Erlenmeyer flask;
filling the flask with about from 75 to 100 mL of H₂SO₄ (in 98.5% concentration);
placing the flask on a stirring hot place and heating until the temperature increase-up to about 220° C., while stirring vigorously and covering the flask with a watch glass;
allowing the flask for at least 4 hours and then cooling to the temperature of about from 50 to 60° C.;
filtering by vacuum filtration using a filter with two washes of the flask with about 75 ml of H₂SO₄ (in 98.5% concentration), respectively and with at least three washes with about 100 mL of water, respectively; and
drying glass fibers and filter in aluminium try at 105° C. until the weight no longer changes (at least for 1 hour).

With the glass fibers isolated by either an ash method or a chemical method, the glass fibers can be dispersed into a plastic petri dish using low pressure compressed air to facilitate dispersion. The glass fibers are then imaged on an optical microscope with inverted lighting, while adjusting the image magnification depending on the length of glass fibers. The glass fibers are then observed, the lengths are measured with the microscope and the fiber length distribution is reported in a histogram.

According to an embodiment of the present invention, the glass fibers (GF) have a diameter of 5 μm or more, preferably 6 μm or more. In some particular embodiments, the glass fibers (GF) have a diameter of from 5 μm to 20 μm. In other particular embodiments, the glass fibers (GF) have a diameter of from 6 μm to 15 μm.

The morphology of the glass fibers is not particularly limited. The glass fibers can have a circular cross-section (‘round glass fiber’) or a non-circular cross-section (‘flat glass fiber’). Examples of suitable flat glass fibers include, but are not limited to, glass fibers having oval, elliptical and rectangular cross sections. For the glass fibers not having a circular cross-section, the diameter that is mentioned herein is the equivalent diameter which is the diameter of a circle having the same surface as the cross-section of the glass fibers having a non-circular cross-section.

According to a specific embodiment (E*) of the invention, the polyamide molding composition is characterized by set of parameters (S1*) or (S2*) or by sets of parameters (S1*) and (S2*), these sets being as defined herein:

(S1*)

an arithmetic average length (Lₐᵥ) between 300 and 750 μm; and
a proportion of the GFs having a length higher than 400 μm of at least
45% (in numbers) and/or a proportion of the GFs having a length higher
than 500 μm of at least 30.0% (in numbers);
these parameters being obtained from the number-weighted distribution.

(S2*)

an average length (Lₚ) between 400 μm and 1800 μm;
a proportion of the GFs having a length higher than 400 μm of at least
65.0% and/or a proportion of the GFs having a length higher than 500 μm
of at least 50.0%;
these parameters being obtained from the volume-weighted distribution.

All the embodiments and specificities relating to Lₐᵥ, Lₚ and the proportions of glass fibers having a length >400 μm or >500 μm disclosed herein apply also to embodiment (E*).

Each parameter Lₐᵥ, Lₚ and the proportions of glass fibers having a length >400 μm or >500 μm from the number-weighted and from volumed-weighted distributions can take any value as disclosed in this application.

### Time of Failure (t_{F})

As mentioned above, the polymeric molding composition needs to be resistant enough to the thermal stress triggered by a thermal runaway. The longer the time of resistance to the thermal stress, the better for containing the thermal runaway. The polyamide molding composition is characterized by at least one of the time-to-failure parameters (t_{F}; t_{F T1}; t_{F T2}) disclosed below.

UL Solutions (https://www.ul.com/) is a recognized certification company that provides standards and regulations. UL Solutions have developed the “Torch-and-Grit” (TaG) test which is disclosed in UL2596 “Test Method for Thermal and Mechanical Performance of Battery Enclosure Materials” and which corresponds to the dynamic stresses found in an actual automotive battery thermal runaway event.

The polyamide molding composition is characterized by a time-to-failure (t_{F}) of at least 90.0 s, preferably at least 100.0 s, t_{F} being measured on a sample having a thickness of 3 mm and according to the Torch-and-Grit” (TaG) test disclosed in UL 2596, issue No 2 released on 8 Sep. 2023. t_{F} under these conditions is typically at most 190.0 s.

Applicant has also developed a similar test T1 that is disclosed in the Experimental Section. This test uses a temperature of flame lower than in UL 2596, issue No 2. The polyamide molding composition is characterized by a time-to-failure (t_{FT1}) of at least 5.0 min, preferably at least 6.0 min, more preferably at least 10.0 min, t_{F T1} being determined according to the protocol T1 defined in the Experimental Section. t_{F T1} under these conditions is typically at most 20.0 min. Failure is defined as either a flame observed on the cold side due to burn through or a plaque sample falling through the hollow ceramic platform under its own weight.

Applicant has also developed a similar test T2 that is disclosed in the Experimental Section. This test uses is the same as in UL 2596, issue No 2, except that there is no grit and the temperature of the flame is lower. The polyamide molding composition is characterized by a time-to-failure (t_{F T2}) of at least 500.0 s, preferably at least 750.0 s, more preferably at least 1000.0 s, preferably at least 1400.0 s, t_{F T2} being determined according to the protocol T2 defined in the Experimental Section. t_{F T2} under these conditions is typically at most 2000.0 s.

The polyamide molding composition of the invention can be characterized by the time-to-failure (t_{F}) as disclosed herein.

The polyamide molding composition of the invention can be characterized by the time-to-failure (t_{F T1}) as disclosed herein.

The polyamide molding composition of the invention can be characterized by the time-to-failure (t_{F T2}) as disclosed herein.

### Mechanical Properties

The polyamide molding composition of the invention typically exhibits an impact strength (notched Izod; room temperature; measured according to ISO 180; specimen size: type 1A bar) between 10.0 and 25.0 KJ/m², preferably between 15.0 and 25.0 KJ/m², preferably between 20.0 and 25.0 KJ/m².

The polyamide molding composition of the invention typically exhibits a tensile strength at break (speed: 5 mm/min; measured according to ISO 527; specimen size: type 1A bar) of at least 180 MPa.

### Polyamide (PA)

The polyamide (PA) present in the polyamide molding composition of the invention can be any one of the polyamides herein disclosed, notably according to embodiment (E).

The polyamide (PA) comprises recurring units (R_{PA}) according to formulae (I) and/or (II), respectively:

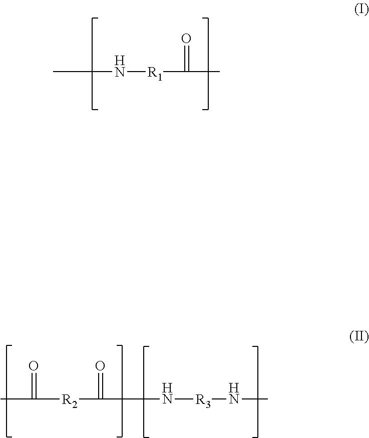

wherein:
R₁ is selected from the group consisting of a C₂-C₁₈ alkylene group;
R₂ is selected from the group consisting of a C₂-C₁₈ alkylene group; a C₆-C₁₈ cycloalkylene group; and a C₆-C₁₈ arylene group and combination thereof; and
R₃ is selected from the group consisting of a C₄-C₁₈ alkylene group; a C₆-C₁₈ cycloalkylene group; a C₈-C₁₈ arylene group; a divalent radical derived from bis(aminomethyl)cyclohexane selected from the group consisting of 1,3-bis(aminomethyl)cyclohexane (“1,3-BAC”), 1,4-bis(aminomethyl)cyclohexane (“1,4-BAC”), and combination thereof.

The recurring units (R_{PA}) are formed from the condensation of a reaction mixture (RM) comprising:
a amino acid component comprising at least one amino acid of formula (III) NH₂—R₁—COOH); and/or
at least one lactam; and/or
a dicarboxylic acid component (a) comprising at least one dicarboxylic acid of formula (IV) HOOC—R₂—COOH); and a diamine component (b) comprising at least diamine of formula (V) H₂N—R₃—NH₂.

The alkylene group may be linear or branched. The alkylene group is preferably of formula —(CH₂)ₙ— where n is an integer between 2 and 18 or between 4 and 18.

The arylene group is preferably a phenylene group.

According to a preferred embodiment, the polyamide (PA) comprises recurring units of formula (II) only. Recurring units (R_{PA}) are then formed from the condensation of a dicarboxylic acid component (a) comprising at least one dicarboxylic acid of formula (IV) and a diamine component (b) comprising at least one diamine of formula (V).

The proportion of recurring units (R_{PA}) in the polyamide (PA) is preferably at least 95.0 mol %, preferably at least 98.0 mol %, preferably at least 99.0 mol %, this proportion being provided relative to the total number of moles of recurring units in the polyamide (PA).

Non-limitative examples of amino acids suitable for use in manufacturing polyamides are notably 6-aminohexanoic acid, 9-aminononanoic acid, 10-aminodecanoic acid, 11-aminoundecanoic acid, 12-aminododecanoic acid, 13-aminotridecanoic acid and combinations thereof.

Non-limitative examples of lactams suitable for use in manufacturing polyamides are β-propiolactam, γ-butyrolactam, δ-valerolactam, ε-caprolactam, lauryl lactam and combinations thereof.

Non-limitative examples of dicarboxylic acids in the dicarboxylic acid component (a) are notably phthalic acids (including isophthalic acid (I) and terephthalic acid (T)), 2,5-pyridinedicarboxylic acid, 2,4-pyridinedicarboxylic acid, 3,5-pyridinedicarboxylic acid, 2,2-bis(4-carboxyphenyl) propane, bis(4-carboxyphenyl) methane, 2,2-bis(4-carboxyphenyl) hexafluoropropane, 2,2-bis(4-carboxyphenyl) ketone, 4,4′-bis(4-carboxyphenyl) sulfone, 2,2-bis(3-carboxyphenyl) propane, bis(3-carboxyphenyl) methane, 2,2-bis(3-carboxyphenyl) hexafluoropropane, 2,2-bis(3-carboxyphenyl) ketone, bis(3-carboxyphenoxy)benzene, naphthalene dicarboxylic acids, including 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid, oxalic acid, malonic acid, succinic acid, glutaric acid, 2,2-dimethyl-glutaric acid, 1,4-cyclohexane dicarboxylic acid, adipic acid, 2,4,4-trimethyl adipic acid, pimelic acid, suberic acid, sebacic acid, undecanedioic acid, dodecanedioic acid and combination of two of more of said dicarboxylic acids.

Non-limitative examples of diamines in the diamine component (b) are notably 1,2-diaminoethane, 1,2-diaminopropane, propylene-1,3-diamine, 1,3-diaminobutane, 1,4-diaminobutane, 1,5-diaminopentane, 1,5-diamino-2-methylpentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2.3-dimethylbutane, 1,2-diamino-1-butylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2dimethylheptane, 1,10-diaminodecane, 1,8-diamino-1,3-imethyloctane, 1,8-diamino-1,4-dimethyloctane, 1,8-diamino-2,4-dimethyloctane, 1,8-diamino-3,4-dimethyloctane, 1,8-diamino-4,5-dimethyloctane, 1,8-diamino-2,2-dimethyloctane, 1,8-diamino-3,3-dimethyloctane, 1,8-diamino-4,4-dimethyloctane, 1,6-diamino-2,4-diethylhexane, 1.9-diamino-5-methylnonane, 1,11-diaminoundecane, 1,12-diaminododecane, 1,13-diaminotridecane, 1,3-bis(aminomethyl)cyclohexane, para-diaminodicyclohexylmethane, 4,4′-methylene bis(2-methylcyclohexylamine), isophorone diamine, meta-phenylene diamine, meta-xylylene diamine, para-xylylene diamine, 1,3-BAC, 1,4-BAC and combination of two of more of said diamines.

In the present invention, the reaction mixture (RM) may further comprise a mono acid and/or a mono amine as an end-capping agent. Non-limitative examples of end-capping agents are acetic acid, propanoic acid, benzoic acid, benzyl amine, 1-aminohexane and 1-aminododecane.

In one embodiment, the polyamide (PA) is a polyamide 66, a polyamide 6 or blends thereof.

### Embodiment (E)

According to a preferred embodiment (E) of the present invention, the polyamide (PA) is a partially aromatic (aka semi-aromatic) polyamide.

According to embodiment (E), the recurring units (R_{PA}) of polyamide (PA) preferably result from the condensation of:
a dicarboxylic acid component (a) comprising: (i) at least one phthalic acid selected from the group consisting of isophthalic acid (I), terephthalic acid (T) and combination of I and T, and (ii) optionally at least one dicarboxylic acid of formula (IV), where R₂ is selected from the group consisting of a C₂-C₁₈ alkylene group, a C₆-C₁₈ cycloalkylene group and combination thereof; and
a diamine component (b) comprising at least one diamine of formula (V), where R₃ is selected from the group of a C₄-C₁₈ alkylene, a divalent radical derived from bis(aminomethyl)cyclohexane selected from the group consisting of 1,3-BAC, 1,4-BAC and combination thereof.

The dicarboxylic acid component (a) more particularly consists essentially of or consists of: (i) at least one phthalic acid selected from the group consisting of isophthalic acid (I), terephthalic acid (T) and combination of I and T and (ii) optionally at least one dicarboxylic acid of formula (IV) where R₂ is selected from the group consisting of a C₂-C₁₈ alkylene group, a C₆-C₁₈ cycloalkylene group and combination thereof.

The diamine component (b) more particularly consists essentially of or consists of at least one diamine of formula (V) where R₃ is selected from the group of a C₄-C₁₈ alkylene, a divalent radical derived from bis(aminomethyl)cyclohexane selected from the group consisting of 1,3-BAC, 1,4-BAC and combination thereof.

R₂ is more particularly selected from the group consisting of a C₄-C₈ alkylene group, a cycloalkylene group and combination thereof.

R₃ is more particularly selected from the group consisting of a C₄-C₈ alkylene group, a divalent radical derived from bis(aminomethyl)cyclohexane and combination thereof.

Polyamide (PA) may more particularly be such that its recurring units consist of the recurring units (R_{PA}) formed from the polycondensation of a diamine component (A) and a dicarboxylic acid component (B), where the diamine component (A) consist essentially of or consists of:
between 55.0 mol % and 75.0 mol % of one or more C₄-C₈ aliphatic diamines;
between 25.0 mol % and 45.0 mol % of an aliphatic diamine selected from the group consisting of 1,9-nonanediamine, 1,10-decanediamine and combination thereof;
between 0 mol % and 10.0 mol % of a bis(aminomethyl)cyclohexane selected from the group consisting of 1,3-BAC, 1,4-BAC and combination thereof;
where mol % is relative to the total number of moles of diamines in the diamine component (A) and where “consist essentially” means that diamine component (A) consists of the C₄-C₈ aliphatic diamine(s), the other aliphatic diamine, the bis(aminomethyl)cyclohexane and up to 1.5 mol %, preferably up to 1.0 mol %, preferably up to 0.5 mol %, of an additional diamine other than the C₄-C₈ aliphatic diamine(s), the other aliphatic diamine and the bis(aminomethyl)cyclohexane;
   and the dicarboxylic acid component (B) consist essentially of or consists of:
between 90.0 mol % and 100 mol % of terephthalic acid,
between 0 mol % and 10.0 mol % of a dicarboxylic acid selected from the group consisting of C₆-C₁₈ aliphatic dicarboxylic acid, isophthalic acid and combination thereof; and
between 0 mol % and 10.0 mol % of 1,4-cyclohexanedicarboxylic acid,
where mol % is relative to the total number of moles of dicarboxylic acids in the dicarboxylic acid component (B) and where “consist essentially” means that dicarboxylic acid component (B) consists of terephthalic acid, the other dicarboxylic acid and 1,4-cyclohexanedicarboxylic acid and up to 1.5 mol %, preferably up to 1.0 mol %, preferably up to 0.5 mol %, of an additional dicarboxylic acid other than terephthalic acid, the other dicarboxylic acid and 1,4-cyclohexanedicarboxylic acid;
   wherein the bis(aminomethyl)cyclohexane or the 1,4-cyclohexanedicarboxylic acid or both exhibit a proportion of greater than 0.5 mol % in respectively the diamine component (A) or in the dicarboxylic acid component (B). This polyamide is referred to as polyamide (PA1).

Polyamide (PA) may more particularly be such its recurring units consist of the recurring units (R_{PA}) formed from the polycondensation of a diamine component (A) and a dicarboxylic acid component (B), where the diamine component (A) consist essentially of or consists of:
between 55.0 mol % and 75.0 mol % of one or more C₄-C₈ aliphatic diamines;
between 25.0 mol % and 45.0 mol % of an aliphatic diamine selected from the group consisting of 1,9-nonanediamine, 1,10-decanediamine and combination thereof;
between 0 mol % and 10.0 mol % of a bis(aminomethyl)cyclohexane selected from the group consisting of 1,3-BAC, 1,4-BAC and combination thereof;
where mol % is relative to the total number of moles of diamines in the diamine component (A) and where “consist essentially” means that diamine component (A) consists of the C₄-C₈ aliphatic diamine(s), the other aliphatic diamine, the bis(aminomethyl)cyclohexane and up to 1.5 mol %, preferably up to 1.0 mol %, preferably up to 0.5 mol %, of an additional diamine other than the C₄-C₈ aliphatic diamine(s), the other aliphatic diamine and the bis(aminomethyl)cyclohexane;
   and the dicarboxylic acid component (B) consist essentially of or consists of:
between 90.0 mol % and 100 mol % of terephthalic acid,
between 0 mol % and 10.0 mol % of a dicarboxylic acid selected from the group consisting of C₆-C₁₈ aliphatic dicarboxylic acid, isophthalic acid and combination thereof; and
between 0.5 mol % and 10.0 mol % of 1,4-cyclohexanedicarboxylic acid,
where mol % is relative to the total number of moles of dicarboxylic acids in the dicarboxylic acid component (B) and where “consist essentially” means that dicarboxylic acid component (B) consists of terephthalic acid, the other dicarboxylic acid and 1,4-cyclohexanedicarboxylic acid and up to 1.5 mol %, preferably up to 1.0 mol %, preferably up to 0.5 mol %, of an additional dicarboxylic acid other than terephthalic acid, the other dicarboxylic acid and 1,4-cyclohexanedicarboxylic acid. This polyamide is referred to as polyamide (PA2).

According to an embodiment, notably for polyamide PA1 and PA2, the C₄-C₈ aliphatic diamine present in the diamine component (a) is 1,6-diaminohexane (aka hexamethylenediamine).

Polyamide (PA) according to embodiment (E) is more particularly selected from the group consisting of:
6T/6I/66;
6T/66;
6T/6I;
6T/10T;
6T/10T/BACT, where BAC is 1,3-BAC and/or 1,4-BAC, preferably 1,3-BAC;
6T/BACT/66/BAC6, where BAC is 1,3-BAC and/or 1,4-BAC, preferably 1,3-BAC;
6T/10T/6.CHDA/10.CHDA where CHDA is 1,4-cyclohexanedicarboxylic acid. The recurring units (R_{PA}) of this polyamide are formed from the condensation of a dicarboxylic acid component consisting of T and 1,4-cyclohexanedicarboxylic acid and a diamine component consisting of 1,6-diaminohexane and 1,10-diaminodecane; and
6T/9T/6.CHDA/9.CHDA where CHDA is 1,4-cyclohexanedicarboxylic acid. The recurring units (R_{PA}) of this polyamide are formed the condensation of a dicarboxylic acid component consisting of T and 1,4-cyclohexanedicarboxylic acid and a diamine component consisting of 1,6-diaminohexane and 1,9-diaminononane;
a combination thereof.

All polyamides mentioned herein are prepared by polycondensation. This polymerization technique comprises a step in which a reaction mixture comprising all the monomers is heated at a temperature sufficient to induce the formation of amide bonds. The temperature at which the reaction mixture is heated is generally at least 200° C., even preferably at least 250° C. The conditions provided in the experimental section of EP 4021959 B1 can be followed.

The polyamide (PA) and the polyamide molding composition should preferably exhibit good thermal resistance even in normal conditions.

The polyamide (PA), notably according to embodiment (E), is semi-crystalline.

The polyamide (PA), notably according to embodiment (E) and notably polyamide (PA1) and polyamide (PA2), preferably exhibits a Hₘ which is at least 30.0 J/g, preferably at least 35.0 J/g. Hₘ is generally at most 60.0 J/g.

The polyamide (PA), notably according to embodiment (E) and notably polyamide (PA1) and polyamide (PA2), preferably exhibits a melting temperature (Tₘ) of at least 295° C., preferably at least 300° C. Tₘ is generally 340° C. or less. Tₘ can be measured by DSC according to ASTM D3418.

Tₘ is preferably at least 310° C.

The polyamide (PA), notably according to embodiment (E) and notably polyamide (PA1) and polyamide (PA2), preferably exhibits a glass transition temperature (T_{g}) of at least 90° C., preferably at least 100° C. T_{g} is preferably at least 120° C., preferably at least 130° C. T_{g} is generally no more than 170° C. T_{g} can be measured by DSC according to ASTM D3418.

Suitable polyamides for the preparation of the polyamide molding composition are commercially available under the trade name of AMODEL® from Solvay Specialty Polymers USA, LLC.

The polyamide (PA) disclosed herein, notably polyamide (PA1), (PA2) or any one of the polyamides disclosed above, is preferably a semi-aromatic polyamide exhibiting the following properties:
a melting temperature (Tₘ) of at least 300° C.;
a heat of fusion (Hm) of at least 30.0 J/g;
a glass transition temperature (Tg) of at least 100° C.

Conditions provided in the Experimental Section are conveniently used for determining the thermal properties of polyamide (PA).

### Glass Fibers (GFs)

The glass fibers used for the preparation of the polyamide molding composition are endless glass fibers, i.e. continuous glass fibers, or chopped glass fibers. Although it is possible to use two types of glass fibers for the preparation of the polyamide molding composition of the invention, it is preferred to use only one type of glass fibers, notably having a uniform diameter.

An example of glass fibers that can be used for the preparation of the polyamide molding composition of the invention is the Tufrov® 4510 roving from Nippon Electric Glass (see https://www.neg.co.jp/en/assets/file/product/fiber/e-roving/e-roving_list/TufRov_4510_LFT_roving_210907.pdf). These E-glass glass fibers generally exhibit a fiber diameter between 12 and 17 μm and roving tex above 1000 g/km.

These glass fibers are those used in the method of preparation of the polyamide molding composition as disclosed herein. Their length is reduced in the method of preparation of pellets (p) and in the method of preparation so disclosed.

Glass fibers are typically contain several oxides. The main oxide is silica (SiO₂), while the other oxides such as calcium oxide (CaO), sodium oxide (Na₂O) and alumina (Al₂O₃) are incorporated to adjust the properties of interest, for instance to lower the melting temperature and to impede crystallization.

### Flame Retardant (FR)

The polyamide molding composition comprises also at least one FR.

The FR is preferably halogen-free.

The FR is preferably an organophosphorous compound. In another embodiment, the FR comprises an organophosphorous compound and a flame-retardant synergist. In the context of the present invention, the organophosphorous compound is notably any one of the organophosphorous compound disclosed herein.

In a particular embodiment of the present invention, the FR is or comprises at least one organophosphorous compound selected from the group consisting of phosphinic salts (phosphinate), diphosphinic salts (diphosphinate) and combination thereof.

In a particular embodiment of the present invention, the FR is or comprises at least one organophosphorous compound selected from the group consisting of phosphinic salts (phosphinate) of formula (a), diphosphinic salts (diphosphinate) of formula (b) and combination thereof:

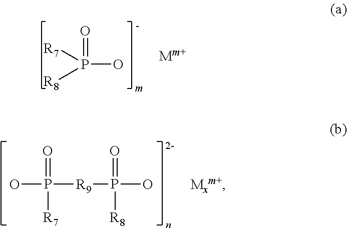

wherein R⁷ and R⁸, identical or different, are preferably C₁-C₆ alkyl, linear or branched, or aryl; R⁹ is C₁-C₁₀ alkylene, linear or branched, C₆-C₁₀ arylene, alkylarylene or arylalkylene; M is Mg, Ca, Al, Sb, Sn, Ge, Ti, Zn, Fe, Zr, Ce, Bi, Sr, Mn, Li, Na, K or a protonated nitrogen base; m is 1 to 4; n is 1 to 4; and x is 1 to 4.

m, n and x are typically such that the molecules of formula (a) or (b) are neutral.

In formulae (a) and (b), M is preferably Ca, Al or Zn; the protonated nitrogen bases are preferably protonated bases of ammonia, melamine, triethanolamine, in particular NH₄⁺; R⁷ and R⁸, identical or different, are preferably C₁-C₆ alkyl, linear or branched and/or phenyl, particularly preferably methyl, ethyl, n-propyl, isopropyl, n-butyl, tert-butyl, n-pentyl and/or phenyl. R⁹ is preferably methylene, ethylene, n-propylene, isopropylene, n-butylene, tert-butylene, n-pentylene, n-octylene, or n-dodecylene. In a particular embodiment, R⁹ is phenylene or naphthylene.

According to an embodiment of the present invention,
M is Mg, Ca, Al or Zn;
m is 2 or 3; and
n is 1 or 3; and
x is 1 or 2.

The FR is more particularly an organo-phosphorous of formula (a).

Phosphinates are preferred as organophosphorous compound. Aluminum phosphinates, calcium phosphinates, and zinc phosphinates are particularly preferred. Among aluminum phosphinates, aluminium ethylmethylphosphinate and aluminium diethylphosphinate are preferred. In a particularly preferred embodiment, the organophosphorous compound is aluminium diethylphosphinate.

The following FRs may be used in the molding composition: a mixture of 80 wt % of aluminum salt of diethylphosphinic acid and 20 wt % of aluminium phosphate; aluminum salt of diethylphosphinic acid.

In an embodiment of the present invention, the FR comprises a (di)phosphinate salt and a nitrogen-containing synergist.

Synergistic combinations of the specified phosphinates with nitrogen-containing compounds which have more effective action than the phosphinates alone in various polymers are also in accordance with the invention.

The nitrogen-containing synergists preferably comprise benzoguanamine, tris(hydroxyethyl) isocyanurate, allantoin, glycoluril, melamine, melamine cyanurate, dicyandiamide, guanidine, carbodiimides, etc.

The nitrogen-containing synergists preferably comprise condensation products of melamine. By way of example, condensation products of melamine are melem, melam, or melon.

The phosphorus/nitrogen-containing synergists may comprise reaction products of melamine with phosphoric acid or with condensed phosphoric acids. By way of example, these are dimelamine phosphate, dimelamine pyrophosphate, melamine phosphate, melamine pyrophosphate, melamine polyphosphate, melam polyphosphate, melon polyphosphate, and melem polyphosphate, and mixed polysalts.

The phosphorus/nitrogen-containing synergist may also be ammonium hydrogenophosphate, ammonium dihydrogenophosphate, or ammonium polyphosphate.

Other known flame-retardant synergists may also be optionally included in the polyamide molding composition in accordance with the invention. Examples of such synergists include metal oxides such as silica, iron oxide, titanium oxide, aluminum oxide, magnesium oxide, etc.; metal hydroxides and hydroxides oxides such as aluminum hydroxide, boehmite, magnesium hydroxide; metal salts such as zinc borate, zinc carbonate, magnesium carbonate, barium carbonate, barium metaborate.

Non-limitative examples of FRs include antimony trioxide, antimony pentoxide, antimony-metal compound, zinc borate, alumina trihydrate, magnesium hydroxide, and basalt fibers.

In a particular embodiment, the FR comprises basalt fibers.

### Additive(s) (Add)

The polyamide molding composition may comprise at least one additive (Add), which is different from the flame retardant (FR). The proportion of the additive(s) (Add) is typically between 0 and 15.0 wt %.

In one embodiment, the polyamide molding composition comprises at least one additive (Add) in an amount of from 0 wt % to 10.0 wt %, relative to the total weight of the polyamide molding composition.

The additive (Add) is typically selected from the group consisting of impact modifiers, tougheners, plasticizers, colorants, pigments, antistatic agents, dyes, lubricants (e.g. calcium stearate, magnesium stearate or sodium montanate), thermal stabilizers, light stabilizers, antioxidants, nucleating agents, polymer processing aids, anti-blocking agents, slip agents, antifogging agents, chemical blowing agents, nucleating agents and any combination thereof.

In a preferred embodiment of the present invention, the additive (Add) is selected from the group consisting of impact modifiers, tougheners, plasticizers, colorants, pigments, antistatic agents, dyes, lubricants, antioxidants and any combination thereof.

In another preferred embodiment of the present invention, the additive (Add) is selected from the group consisting of plasticizers, colorants, pigments, antistatic agents, dyes, lubricants, antioxidants and any combination thereof.

### Additional Filler(s)

The polyamide molding composition may further comprise at least one additional filler which is different from the glass fibers (GFs), notably selected from the group consisting of mineral fillers (e.g. talc, mica, kaolin, calcium carbonate, calcium silicate, magnesium carbonate) and glass balls (e.g. hollow glass microspheres).

In one embodiment, the additional filler is selected from the group consisting of calcium carbonate, magnesium carbonate, graphite, carbon black, carbon fiber, carbon nanofiber, graphene, graphene oxide, fullerene, talc, wollastonite, mica, alumina, silica, titanium dioxide, kaolin, silicon carbide, zirconium tungstate, and boron nitride.

### Preparation of the Polyamide Molding Composition of the Invention

The polyamide molding composition can be conveniently obtained by the method comprising the following steps:
step a): introducing into an extruder pellets (p) prepared from a strand made up of a plurality of filaments of GF impregnated by a composition (c) comprising all the components of the polyamide molding composition except the glass fibers (GF);
step b): moulding the composition obtained after step a).

Composition (C) comprises all the components of the polyamide molding composition (that is polyamide(s) (PA), flame-retardant(s) (FR), the optional additive(s) (if present in the polyamide moulding composition) and the optional additional filler(s) (if present in the polyamide moulding composition)) except the glass fibers (GF).

The proportions of the components of composition (c) is typically the following:
polyamide(s) (PA): between 50.0 and 80.0 wt %;
FR(s): between 20.0 and 50.0 wt %;
additive(s) (Add) and additional filler(s): between 0 and 20.0 wt %;
   these proportions being relative to the total weight of composition (c).

In step a), the pellets (p) are introduced into an extruder, notably in a single screw extruder.

The technique used in step b) for moulding the composition obtained after step a) is typically selected in the group of extrusion molding, injection molding, blow molding, rotomolding, overmolding, compression molding and drawing extrusion molding. Step b) may be performed according to any one of the listed techniques. Extrusion moulding and injection moulding are convenient methods that allows the preparation of the polyamide moulding composition of the invention. The technique used in step b) is notably injection moulding.

The polyamide molding composition, notably at the end of step b), is typically in the form of pellets or in the form of a shaped article.

The conditions provided in the examples of the Experimental Section for the preparation of the polyamide molding composition can be followed (see § 2) Injection moulding).

### About Pellets (p)

Pellets (p) are prepared from a strand made up of a plurality of filaments of GF impregnated by the composition (c) comprising all the components of the polyamide molding composition except the glass fibers (GF).

The pellets (p) are typically prepared by a method which comprises the steps of:
putting into contact the composition (c) in the molten form onto a strand made up of a plurality of filaments of GF;
passing the composite so obtained through an impregnation die;
after the die, the composite is cooled down and cut into pellets (p).

An example of impregnation die that can be used is disclosed in EP 0320653, US 2013/0145986 A1 or in U.S. Pat. No. 5,277,566.

The viscosity of the molten composition (c) should be low enough to allow a good spreading and impregnation of the composition (c) around the fibers, notably for thoroughly “wetting” and encapsulating the fibers. To this effect, the temperature of the molten composition (c) needs to be high enough to decrease its viscosity. The temperature of the molten composition (c) should be high enough to decrease the viscosity and be below the decomposition temperature of the composition (c).

The temperature of the molten composition (c) is typically at least Tm+40° C., preferably at least Tm+50° C., where designates the melting temperature of polyamide (PA). In the case of a combination of polyamide(s) (PA), the melting temperature to be taken into account is the highest Tm. generally between 35° and 400° C.

The speed of the strand during the impregnation is typically between 1.0 and 20.0 m/min, more particularly between 5.0 and 15.0 m/min.

The length of pellets (p) is typically between 4 and 15 mm, more preferably between 5 and 12 mm. The higher the length, the higher Lₐᵥ and Lₚ in the polyamide molding composition.

The invention also relates to a method of preparation of pellets (p) comprising the following steps:
putting into contact a composition (c) in the molten form onto a strand made up of a plurality of filaments of GF;
passing the composite so obtained through an impregnation die;
after the die, the composite is cooled down and cut into pellets (p);
   wherein composition (c) comprises polyamide (PA1) or polyamide (PA2); at least one FR as disclosed herein; optionally at least one additive (Add) as disclosed herein; optionally an additional filler (different from GFs) as disclosed herein.

The proportions of the components of composition (c) are notably the following:
polyamide (PA1) or (PA2): between 50.0 and 80.0 wt %;
FR(s): between 20.0 and 50.0 wt %;
additive(s) (Add) and additional filler(s): between 0 and 20.0 wt %;
   these proportions being relative to the total weight of composition (c).

Polyamide (PA1) may more particularly be a polyamide selected in the group consisting of 6T/10T/BACT; 6T/10T/6.CHDA/10.CHDA; 6T/9T/6.CHDA/9.CHDA and combination thereof.

The conditions provided in the examples of the Experimental Section for the impregnation can be followed (see § 1) Compounding).

According to a preferred embodiment, the polyamide (PA) in composition (c) is a semi-aromatic polyamide as defined in embodiment (E). Polyamide (PA) is notably any one of the semi-aromatic polyamide as defined in embodiment (E).

### Shaped Article

According to an embodiment, the polyamide molding composition, notably at the end of step b), is in the form of a shaped article.

The article may be a battery enclosure or any other part of the battery such as a cover of a battery enclosure. The function of the battery enclosure is to store and protect the battery of any electrical vehicle EV (e.g. hybrid, plug-in-hybrid and fully EV). An example of battery enclosure is disclosed in US 2010/0273034 A1.

The article may also be a housing, a wall (e.g. internal or external wall) or the cover of a battery enclosure. An example of housing is disclosed in WO 2013/098121. Examples of articles made of a polymeric material are disclosed in EP 3460870.

An additional measure of the electrical properties required for the articles intended for electric or electronic devices/parts such as electrical connectors is the Comparative Tracking Index (CTI). CTI is used to measure the electrical breakdown properties of an insulating material. Tracking is defined as the current flowing on the surface of an insulator between two electrodes, which may be caused through degradation of the insulator. In addition, tracking resistance is the ability of an insulator to prevent such formation of current.

CTI may be measured according to IEC 60112, which indicates the relative resistance of solid electrical insulating materials to tracking for voltages up to 600V, when the surface is exposed under electric stress to water with the addition of contaminants such as ammonium chloride solution. CTI value refers to a voltage at which no tracking occurs after 50 drops of the solution, provided that no tracking occurs after 100 drops of solution at another voltage of 25V lower. The higher the value, the more resistant is the material.

In one embodiment, the polyamide molding composition according to the present invention exhibits CTI at 600V or greater, corresponding to the highest Performance Level Category (PLC) 0.

### Use

The polyamide molding composition of the invention can be used for the preparation of at least one part of a battery enclosure, this part being notably selected in the group consisting of the housing, an internal wall or the cover of the battery enclosure.

### EXPERIMENTAL SECTION

### Raw Materials

Polyamide (PA): Amodel® PPA Bios commercially available from Solvay Specialty Polymers USA, LLC. Tm is around 315° C.;
GF (I): TufRov™ 4510, E-glass fibers having fiber diameter of 12 μm, commercially available from Nippon Electric Glass;
GF(II): ChopVantage® HP3610, E-glass fibers having nominal chop length of 3.2 mm and nominal fiber diameter of 10 μm, commercially available from Nippon Electric Glass;
Flame retardant (FR): Exolit® OP1230 commercially available from Clariant GmbH.

Thermal properties of polyamide (PA): Tg, Tm and Hm are measured by Differential Scanning calorimetry (“DSC”) according to ASTM D3418 using a heating and cooling rate of 20° C./min.

The wt % of each component of the polyamide molding composition are indicated in Table 1 or Table 2 below.

The polyamide molding compositions were prepared by injection molding pellets obtained after compounding step which is disclosed below.

### 1) Compounding

Conditions of E1-E3 (Inventive Examples): the PA was first tumble blended for 30 minutes in a 50-gallon drum to create a premix of the resin with additives (ADK Pep-36 and ADK AO-80 as antioxidants, commercially available from Adeka) to produce premixes. The premixes were then metered to the feed throat of a 25 mm Berstorff co-rotating intermeshing twin-screw extruder having 8 barrel sections. The resin mix was metered at a rate of 78.00 lb/hr using a gravimetric feeder. The FRs were fed into barrel 7, using a gravimetric feeder, at a rate of 22.5 lb/hr. Vacuum venting was provided at barrel section 8 achieving a vacuum level of 25 in Hg to remove moisture and any other volatile residues from the compounds. The extrudates were kept hot at 370° C. before adding the same to the continuous strands of GFs (I). The polymer coating continuous glass strands were first cooled and cut into pellets (p) of 9 mm length.

These conditions used for the preparation of the pellets (p) are referenced as conditions A.

CE1-CE2 (Comparative Examples): the PA was first tumble blended for 30 minutes in a 50-gallon drum to create a premix of the resins with additives (ADK Pep-36 and ADK AO-80 as antioxidants, commercially available from Adeka) to produce premixes. The premixes were then metered to the feed throat of a 25 mm Berstorff co-rotating intermeshing twin-screw extruder having 8 barrel sections. The resin mix was metered at a rate of 13.00 lb/hr using a gravimetric feeder. The GFs (II) were fed at barrel section 6, also using a gravimetric feeder at a rate of 8.25 lb/hr. The FRs were fed into barrel 7, using a gravimetric feeder at a rate of 3.75 lb/hr. The total compounding throughput was at a rate of 25 lb/hr. The barrel section temperature was set during compounding to 216° C. (barrel 2), 306° C. (barrel 3), 340° C. (barrels 3-4), and 300° C. (barrels 5-9; adaptor; die). The temperature of the melt was monitored during the compounding using a handheld temperature probe and was determined to be in the range of from 330° C. to 350° C. Vacuum venting was provided at barrel 8 achieving a vacuum level of 25 in Hg to remove moisture and any other volatile residues from the compound. The extrudates were stranded from the die, cooled in a water bath and then cut into cylindrical pellets having approximately 3.0 mm in length and 2.7 mm in diameter.

These conditions used for the preparation of the pellets of the comparative examples are referenced as conditions B.

### 2) Injection Molding (IM)

The pellets obtained from the compounding above detailed (conditions A or B) were first dried at 82° C. in a desiccated convection air oven for at least 8 hours (overnight) in preparation for the injection molding. Injection molding was performed to produce articles for testing and performance measurement, by using an injection molding machine SE180EV-A equipped with a hopper dryer (this machine is commercially available from Sumitomo and is equipped with a screw diameter 50 mm) to maintain the dried pellets moisture content. The cycle time varied from 36.0 to 47.0 seconds and the fill peak pressure was adjusted between 7000 and 9000 psi. The temperature of the composition during injection was about 271° C. The dimensions of the plaques produced were 152 mm×152 mm×2 mm and 101 mm×101 mm×2 mm. Further ISO tensile bars were also injection molded according to ISO180.

### Measurement of Length of Glass Fibers (GFs)

The length of GFs was measured according to ISO 22314:2006, with minor modifications to ease the tracking of the length optically. The molded plaque parts were cut with a handsaw in 10 mm×10 mm×2 mm size and the samples were stored in an oven at 525° C. for 4.5 hours. Once fibers were isolated according to the ash method using muffle furnace as described in the specification, GFs were dispersed into a plastic petri dish using low pressure compressed air to facilitate dispersion.

The isolated GFs were imaged using an optical microscope and the length of 200 or more GFs were measured on the images.

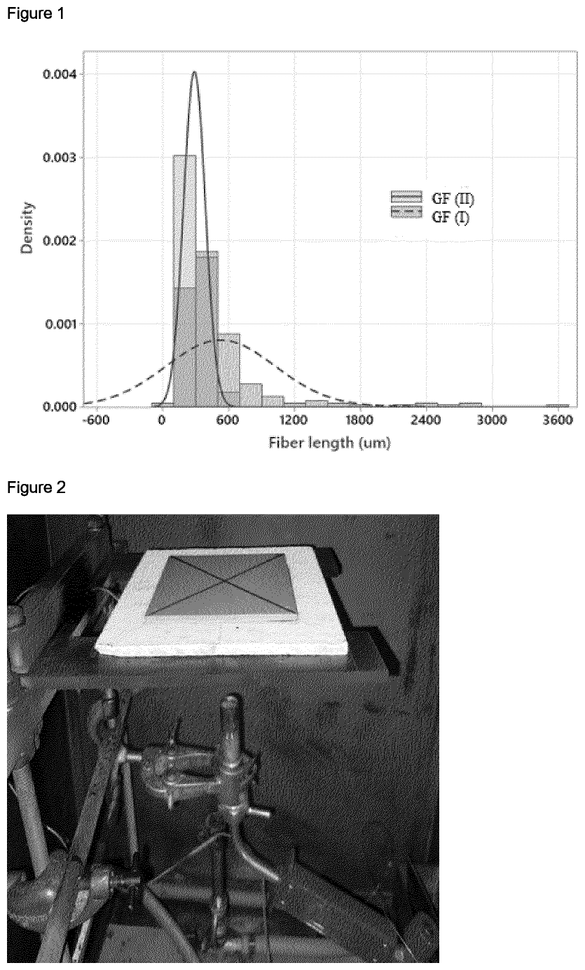

Fiber length distribution (number-weighted distribution) was reported with a histogram of fiber lengths as shown in FIG. 1.

### Test T1

Test T1 was conducted according to the following protocol, according to the guidance made from UL Solutions:

Protocol of test T1: A 2.5 kW (8600 Btu/h) propane gas torch was used to reach a flame
temperature of 1090 ± 50° C. The samples in the form of plaques (152 mm × 152 mm ×
2 mm) were placed horizontally onto a ceramic platform such that the material was
presented perpendicular to the flame which impinged the plaque centroid through a
90 mm × 90 mm gap in the platform.
What was measured was the time-to-failure (t_{F T1}), where failure is defined as either a
flame observed on the cold side due to burn through, or a plaque sample falling through
the hollow ceramic platform under its own weight.

### Test T2

Test T2 was conducted according to the following protocol, according to the guidance made from UL Solutions:

Protocol of test T2: this test was done at UL using the same torch and sample mount
setup as mentioned in UL-2596, issue No2 released on 8 Sep. 2023, except that
the temperature of the torch was kept at 1000° C. The torch was placed horizontally. The
samples in the form of plaques (152 mm × 152 mm × 2 mm) were mounted vertically onto
a frame 60 mm away from the torch, as specified in UL-2596.
What was measured was the time-to-failure (t_{F T2}), where failure is defined as either a
flame observed on the cold side due to burn through, or a plaque sample falling through
the hollow ceramic platform under its own weight.

In protocol T2, the temperature of 1000° C. is kept by varying the ratio of methane to oxygen as guided by UL's internal calibration curve for the torch temperature.

The t_{F T1} values provided in Table 1 correspond to an arithmetic mean value obtained with five replicates performed for each composition.

TABLE 1

| | E1 | E2 | E3 | CE1 | CE2 | CE3 |
|---|---|---|---|---|---|---|
| Polyamide (wt %) | 52 | 40 | 40 | 52 | 40 | 40 |
| GF used as starting material | | | | | | |
| GF (I) TufRoy ™ 4510 (wt %) | 33 | 45 | 45 | — | — | — |
| GF (II) ChopVantage ® HP3610 (wt %) | — | — | — | 33 | 45 | 45 |
| Flame retardant (wt %) | 15 | 15 | 15 | 15 | 15 | 15 |
| Conditions of preparation of the | A + IM | A + IM | A + IM | B + IM | B + IM | B + IM |
| polyamide molding composition | | | | | | |

Number-weighted distribution

| | | | | | | |
|---|---|---|---|---|---|---|
| Lav (μm) | 530 | 362 | 402 | 290 | 256 | 224 |
| Proportion of GFs having a length | 73.7 | 51.2 | 64.6 | 22.0 | 12.3 | 14.5 |
| higher than 400 μm (%) | | | | | | |
| Proportion of GFs having a length | 60.7 | 35.7 | 45.8 | 6.7 | 3.8 | 7.2 |
| higher than 500 μm (%) | | | | | | |

Volume weighted-distribution

| | | | | | | |
|---|---|---|---|---|---|---|
| Lp (μm) | 999 | 503 | 528 | 323 | 286 | 276 |
| Proportion of GFs having a length | 92.1 | 72.8 | 81.2 | 32.6 | 19.6 | 28.8 |
| higher than 400 μm (%) | | | | | | |
| Proportion of GFs having a length | 86.3 | 58.9 | 65.1 | 11.5 | 3.8 | 12.0 |
| higher than 500 μm (%) | | | | | | |

Time-to-failure

| | | | | | | |
|---|---|---|---|---|---|---|
| Time-to-failure (t_{F T1}) (min) | >10 | >10 | | 2.5 | 1.9 | |
| Time-to-failure (t_{F T2}) (s) | | | >1500 | | | 115 |
| Time-to-failure (t_{F}) (s) | | | 103 | | | 80 |

In Table 1, “>10” corresponds to a very good result as this means that the test was stopped at 10 min without appearance of flame, which otherwise could have been performed for a longer duration.

CE1 and CE2 in the presence of a FR in combination with GF(II) couldn't pass the test respectively. As is visible with the data of Table I, the polyamide molding composition according to the present invention exhibits outstanding burn resistance in dynamic conditions.

The polyamide molding compositions according to the invention exhibit an impact strength (notched Izod; measured according to ISO 180; specimen size: type 1A bar) between 10.0 and 25.0 kJ/m². The polyamide molding composition according to the invention exhibit an tensile strength at break (speed: 5 mm/min; measured according to ISO 527; specimen size: type 1A bar) of at least 180 MPa.

### Preparation of Additional Polyamide Molding Compositions

Additional polyamide molding compositions were prepared with the method of preparation of the invention. Pellets (p) obtained from a compounding under conditions A were first dried at 82° C. in a desiccated convection air oven for at least 8 hours (overnight) in preparation for the injection molding. Injection molding was performed to produce articles for testing and performance measurement, by using an injection molding machine SE250EV-A equipped with a hopper dryer (this machine is commercially available from Sumitomo and is equipped with a screw diameter 45 mm) to maintain the dried pellets moisture content. The cycle time varied from 36.0 to 47.0 seconds and the fill peak pressure was adjusted between 7000 and 9000 psi. The temperature of the composition during injection was about 271° C. The dimensions of the plaques produced were 152 mm×152 mm×3 mm.

Conditions of the injection molding machine were varied (see Table 2).

TABLE 2

| | E4 | E5 | E6 | E7 | E8 |
|---|---|---|---|---|---|
| Polyamide (wt %) | 40 | 40 | 40 | 40 | 40 |
| GF (I) TufRov ™ 4510 (wt %) | 45 | 45 | 45 | 45 | 45 |
| Flame retardant (wt %) | 15 | 15 | 15 | 15 | 15 |
| Conditions of preparation of the | A + IM | A + IM | A + IM | A + IM | A + IM |
| polyamide molding composition | | | | | |
| Screw speed (rpm) | 160 | 160 | 108 | 160 | 56 |
| Barrel temperature (° C.) | 343 | 315 | 330 | 315 | 343 |
| Injection speed (in/s) | 5.8 | 1.8 | 3.5 | 1.8 | 1.8 |
| Back pressure (psi) | 1500 | 0 | 750 | 1500 | 1500 |
| Lav (μm) | 465 | 662 | 467 | 648 | 533 |
| Proportion of GFs having a length | 70.5 | 81.8 | 69.9 | 83.8 | 78.1 |
| higher than 400 μm (%) | | | | | |
| Proportion of GFs having a length | 56.4 | 72.4 | 55.3 | 72.3 | 65.9 |
| higher than 500 μm (%) | | | | | |
| Lp (μm) | 769 | 1605 | 881 | 1361 | 939 |
| Proportion of GFs having a length | 89.2 | 96.7 | 90.4 | 96.4 | 93.4 |
| higher than 400 μm (%) | | | | | |
| Proportion of GFs having a length | 81.0 | 94.0 | 83.0 | 92.5 | 87.5 |
| higher than 500 μm (%) | | | | | |

1.-45. (canceled)

46. A polyamide molding composition comprising:
between 35.0 and 65.0 wt % of at least one polyamide (PA);
between 20.0 and 60.0 wt % of glass fibers (GFs);
between 10.0 and 30.0 wt % of at least one flame retardant (FR); and
between 0 and 15.0 wt % of at least one additive (Add) other than the flame retardant (FR); selected from the group consisting of impact modifiers, tougheners, plasticizers, colorants, pigments, antistatic agents, dyes, lubricants, thermal stabilizers, light stabilizers, antioxidants, nucleating agents, polymer processing aids, anti-blocking agents, slip agents, antifogging agents, chemical blowing agents, nucleating agents and any combination thereof;
wherein the distribution of the lengths of the GFs in the polyamide molding composition is characterized:
by set of parameters (S1) or (S2) or by sets of parameters (S1) and (S2):
wherein (S1) includes
an arithmetic average length (Lₐᵥ) of 220 μm or more; and
a proportion of the GFs having a length higher than 400 μm of at least 20% (in numbers) and/or a proportion of the GFs having a length higher than 500 μm of at least 15.0% (in numbers);
these parameters being obtained from a number-weighted distribution,
wherein (S2) includes
an average length (Lp) between 400 μm and 1800 μm;
a proportion of the GFs having a length higher than 400 μm of at least 50.0% and/or a proportion of the GFs having a length higher than 500 μm of at least 40.0%;
these parameters being obtained from a volume-weighted distribution.
or
by set of parameters (S1*) or (S2*) or by sets of parameters (S1*) and (S2*):
wherein (S1*) includes
an arithmetic average length (Lₐᵥ) between 300 and 750 μm; and
a proportion of the GFs having a length higher than 400 μm of at least 45% (in numbers) and/or a proportion of the GFs having a length higher than 500 μm of at least 30.0% (in numbers);
these parameters being obtained from the number-weighted distribution,
wherein (S2*) includes
an average length (Lₚ) between 400 μm and 1800 μm;
a proportion of the GFs having a length higher than 400 μm of at least 65.0% and/or a proportion of the GFs having a length higher than 500 μm of at least 50.0%;
these parameters being obtained from the volume-weighted distribution
where average length (Lₚ) is calculated with the following equation:
$$Lp = \frac{{\sum }_{i = 1}^{i = n} ni \times Li \times Li}{{\sum }_{i = 1}^{i = n} ni \times Li}$$
where ni is the number of glass fibers of length Li and n is the number of glass fibers measured;
the number-weighted and volume-weighted distributions being determined after separation of the GFs from the polyamide molding composition by an ash method (a), or a chemical method (b).

47. The polyamide molding composition of claim 46, characterized by:
a time-to-failure (t_{F}) of at least 90.0 s, preferably at least 100.0 s, t_{F} being measured on a sample having a thickness of 3 mm and according to the Torch-and-Grit” (TaG) test disclosed in UL 2596, issue No 2 released on 8 Sep. 2023; and/or
a time-to-failure (t_{F T1}) of at least 5.0 min, being determined according to protocol T1 defined in the Experimental Section; and/or
a time-to-failure (t_{F T2}) of at least 500.0 s, t_{F T2} being determined according to protocol T2 defined in the Experimental Section.

48. The polyamide molding composition according to claim 46, wherein:
the proportion of the GFs having a length higher than 400 μm is between 45% and 90%, this proportion being taken from the number-weighted distribution; and/or
the proportion of the GFs having a length higher than 500 μm of at least 20.0% (in numbers).

49. The polyamide molding composition according to claim 46, wherein (Lₐᵥ) is between 300 and 750 μm and the proportion of the GFs having a length higher than 500 μm is at least 30.0% (in numbers).

50. The polyamide molding composition according to claim 46, wherein (Lav) is:
between 220 μm and 750 μm; or
between 220 μm and 700 μm; or
between 300 μm and 750 μm; or
between 300 μm and 700 μm; or
from 270 μm to 550 μm; or
from 300 μm to 400 μm.

51. The polyamide molding composition according to claim 46, wherein at least 90.0% (in numbers) of the GFs have a length lower than or equal to 3000 μm, this proportion being obtained from the number-weighted distribution.

52. The polyamide molding composition according to claim 46, wherein:
the proportion of the GFs having a length higher than 400 μm is at least 60.0%, this proportion being obtained from the volume-weighted distribution; and/or
the proportion of the GFs having a length higher than 500 μm is at least 50.0%, this proportion being obtained from the volume-weighted distribution.

53. The polyamide molding composition according to claim 46, wherein Lₚ is:
between 400 μm and 1700 μm; or
between 500 μm and 1800 μm; or
between 700 μm and 1800 μm.

54. The polyamide molding composition according to claim 46, wherein the polyamide (PA) comprises at least 95.0 mol %, of recurring units (R_{PA}) resulting from the condensation of:
a dicarboxylic acid component comprising: (i) at least one phthalic acid selected from the group consisting of isophthalic acid (I), terephthalic acid (T) and combination of I and T, and (ii) optionally at least one dicarboxylic acid of formula (IV) HOOC—R₂—COOH), where R₂ is selected from the group consisting of a C₂-C₁₈ alkylene group, a C₆-C₁₈ cycloalkylene group and combination thereof; and
a diamine component comprising at least one diamine of formula (V) H₂N—R₃—NH₂, where R₃ is selected from the group of a C₄-C₁₈ alkylene, a divalent radical derived from bis(aminomethyl)cyclohexane selected from the group consisting of 1,3-bis(aminomethyl)cyclohexane (“1,3-BAC”), 1,4-bis(aminomethyl)cyclohexane (“1,4-BAC”) and combination thereof.

55. The polyamide molding composition according to claim 46, wherein the recurring units of polyamide (PA) consist of the recurring units (R_{PA}) units formed from the polycondensation of a diamine component (A) and a dicarboxylic acid component (B), where the diamine component (A) consists essentially of:
between 55.0 mol % and 75.0 mol % of one or more C₄-C₈ aliphatic diamines;
between 25.0 mol % and 45.0 mol % of an aliphatic diamine selected from the group consisting of 1,9-nonanediamine, 1,10-decanediamine and combinations thereof;
between 0 mol % and 10.0 mol % of a bis(aminomethyl)cyclohexane selected from the group consisting of 1,3-BAC, 1,4-BAC and combinations thereof;
where mol % is relative to the total number of moles of diamines in the diamine component (A) and where consist essentially means that diamine component (A) consists of the C₄-C₈ aliphatic diamine(s), the other aliphatic diamine, the bis(aminomethyl) cyclohexane and up to 1.5 mol %, of an additional diamine other than the C₄-C₈ aliphatic diamine(s), the other aliphatic diamine and the bis(aminomethyl) cyclohexane;
and the dicarboxylic acid component (B) consists essentially of or consists of:
between 90.0 mol % and 100 mol % of terephthalic acid,
between 0 mol % and 10.0 mol % of a dicarboxylic acid selected from the group consisting of C₆-C₁₈ aliphatic dicarboxylic acid, isophthalic acid and combination thereof; and
between 0 mol % and 10.0 mol % of 1,4-cyclohexanedicarboxylic acid,
where mol % is relative to the total number of moles of dicarboxylic acids in the dicarboxylic acid component (B) and where consist essentially means that dicarboxylic acid component (B) consists of terephthalic acid, the other dicarboxylic acid and 1,4-cyclohexanedicarboxylic acid and up to 1.5 mol %, of an additional dicarboxylic acid other than terephthalic acid, the other dicarboxylic acid and 1,4-cyclohexanedicarboxylic acid;
wherein the bis(aminomethyl)cyclohexane or the 1,4-cyclohexanedicarboxylic acid or both exhibit a proportion of greater than 0.5 mol % in respectively the diamine component (A) or in the dicarboxylic acid component (B).

56. The polyamide molding composition according to claim 46, wherein the polyamide (PA) is selected from the group consisting of the following polyamides:
6T/6I/66;
6T/66;
6T/6I;
6T/10T;
6T/10T/BACT, where BAC is 1,3-BAC and/or 1,4-BAC;
6T/BACT/66/BAC6, where BAC is 1,3-BAC and/or 1,4-BAC;
6T/10T/6.CHDA/10.CHDA where CHDA is 1,4-cyclohexanedicarboxylic acid;
and combinations thereof.

57. The polyamide molding composition of claim 46, wherein the polyamide (PA) exhibits a heat of fusion Hₘ which is at least 30.0 J/g, measured by differential scanning calorimetry (DSC) according to ASTM D3418 at a heating rate of 20° C./min; and/or a melting temperature (Tₘ) of at least 295° C., and/or 340° C. or less, Tₘ being measured by DSC according to ASTM D3418;
and/or a glass transition temperature (Tg) of at least 90° C., T_{g} being measured by DSC according to ASTM D3418.

58. The polyamide molding composition according to claim 46, obtained by a method comprising the following steps:
step a): introducing into an extruder pellets (p) prepared from a strand made up of a plurality of filaments of GF impregnated by a composition (c) comprising all the components of the polyamide molding composition except the glass fibers (GF); and
step b): moulding the composition obtained after step a).

59. An article comprising or made of the polyamide molding composition according to claim 46.

60. The article according to claim 59, wherein the article is a housing, a wall or a cover of a battery enclosure.

61. Use of a polyamide molding composition as defined in claim 46 or an article comprising or made of the polyamide molding composition, for the preparation of at least one part of a battery enclosure, this part being selected from the group consisting of a housing, an internal wall or a cover of the battery enclosure.
